(19) United States
(12) Patent Application Publication
(10) Pub. No.: US 2024/0375427 A1
(43) Pub. Date: Nov. 14, 2024

(54) PAINT SYSTEM AND METHOD OF USING SAME

(71) Applicant: Paint Solutions International Ltd., Saskatoon (CA)

(72) Inventors: Daniel Keith Plewis, Calgary (CA); Richard Hesten Rudolph JR. Lewis, Saskatoon (CA)

(21) Appl. No.: 18/433,266

(22) Filed: Feb. 5, 2024

Related U.S. Application Data
(63) Continuation of application No. 18/197,647, filed on May 15, 2023, now abandoned.

(30) Foreign Application Priority Data
May 13, 2023 (CA) 3199604

(51) Int. Cl. B44D 3/12

(52) U.S. Cl. CPC B44D 3/126; B44D 3/127

(57) ABSTRACT

A portable paint system and method of using same is described. The system comprises a container defined by front, back, side and bottom walls. The container has a paint reservoir section and a sloped tray section allowing paint to drain to the reservoir section. The system also includes a lid having two parts coupled to each other or to the container by hinges. The lid is configured to cover the container and can be in a closed or open configuration. When in closed configuration, the lid forms a hermetic seal with the container for storage of paint therein. Wheels are coupled to the bottom wall of the container for portability. A user maneuvers the system without lifting it by using a paint roller, positioning the roller head and neck in dedicated groove/indentation and using the roller handle to move the system with the lid in the open or closed configuration.

### TECHNICAL FIELD

This current invention relates generally to painting solutions and more particularly, to a paint system and method of using same.

### BACKGROUND

Paint kits are well known in the art. Painting kits usually comprise a paint bucket, painting tools such as paint brushes and paint rollers of different sizes and shapes and a painting tray. In use, the paint is poured in the tray of a conventional painting kit. The sleeve of the brush is dipped in the paint provided in the tray. The brush is then rolled on the grid structure provided on the tray for even distribution of the paint and to remove excess paint absorbed therein. Once an acceptable even distribution of paint is attained on the sleeve, the paint brush/roller assembly is ready for use.

It is known in the field that paint dries upon prolonged exposure to air. Using such paint will lead to an uneven application on a surface to be painted. To avoid such problem, only a limited amount of paint is usually poured in the tray to be used. The user is required to pour paint into the tray multiple times as and when the paint in the tray gets depleted. This repeated action of pouring paint into the tray for use causes inefficiency in completing a painting task.

Also, portability of paint tray during a painting job after paint has been poured into the tray is a well-known problem associated with spillage of the paint either from the tray, or the brush or both. Solutions such as lids used to seal the tray with paint and the paint brush in it are known in the art. However, the act of sealing the tray before moving it and requiring the tray to be open after relocating the tray to a new location is time consuming.

There is a desire in the field for a paint system that would address at least some of the above-mentioned deficiencies.

### SUMMARY OF THE INVENTION

The current invention has several aspects. In one aspect of the invention, a portable paint system is described. The system includes a container having a front wall, a back wall, at least two opposing side walls and a bottom wall. The at least two opposing sides walls are coupled to the back wall to form vertical curved pour corners of the container for providing a smooth path for draining paint from the container, the front wall having an indentation at its top edge for receiving a neck section of a paint roller. The container also has a paint reservoir section defined by portions of the at least two opposing side walls, the back wall and the bottom wall. The container further has a tray section having a surface extending between the at least two opposing side walls and extending downwardly in a sloped plane from the front wall to the paint reservoir section. The tray section has a groove extending laterally between the at least two opposing side walls for receiving a roller head of a paint roller. The tray section further has at least one paint channel extending axially along the surface of the tray from the groove to the paint reservoir section. The tray section surface has axial grooves along the surface of the tray section. The paint system also includes a lid dimensioned to be removably coupled to the container and to cover the container in one of a closed configuration and an open configuration. The lid forms a hermetic seal with the container when fully covering the container in the closed configuration. The lid has an indentation corresponding in shape, size and position to the indentation at the top edge of the front wall of the container, such that when the lid is coupled to the container in the closed configuration, an aperture is formed by the combination of the indentation in the front wall of the container and the indentation in the lid, where the aperture is dimensioned to snuggly fit a neck section of a paint roller. The paint system further includes removable wheels coupled to the bottom wall and exterior to the container, where the removable wheels are configured to make the container portable.

In a related embodiment, the portable paint system further includes an insert for placement inside the container atop the tray section, where the insert is shaped and dimensioned to fully overlay the tray section and the paint reservoir section of the container and to allow the lid to maintain a hermetic seal of the container when in the closed configuration.

In another related embodiment, the lid comprises a first part and a second part coupled to each other by a hinge and the lid is moved from the closed configuration to the open configuration by allowing the first part to pivot along the hinge in relation to the second part.

In another related embodiment, the lid comprises a first part coupled to a section of the container by hinges and a second part coupled to the at least two opposite side walls of the container and the lid is moved from the closed configuration to the open configuration by allowing the first part to pivot along the hinges in relation to the second part.

In another related embodiment, the container further has an additional section under the surface of the tray section, where the additional section is configured for storing paint equipment or personal items of a user of the paint system.

In another related embodiment, the tray section of the container has a perforated sloped section.

In yet another related embodiment, the container further comprises an additional section under the surface of the tray section, the additional section is configured for acting as a second paint reservoir.

In yet a further related embodiment, the bottom wall of the additional section is slopped downwardly from the front wall of the container.

In yet a further related embodiment, the bottom wall is removable, which allows for easy access to the additional section of the container below the tray section in the container.

In another related embodiment to the portable paint system, the bottom wall comprises at least one opening plugged by a plug, where the at least one opening is for draining paint from the paint reservoir when the plug is removed, with the container maintained substantially in an upright orientation.

In another related embodiment of the portable paint system, the hermetic seal is achieved when a paint roller head is placed inside the container, the neck section of the paint roller is placed in the aperture such that a handle section of the paint roller extends externally from the container and wherein the lid is placed in the closed configuration.

In another embodiment of the portable paint system, the hermetic seal is achieved when the lid is placed in the closed configuration and wherein the aperture is plugged with an aperture plug to seal the aperture. The hermetic seal in this case is established without the use of a paint roller. This allows for short and/or long term storage of paint and eliminates the need for clean up during a project. It also allows for use of more than one paint during a paint job, including different paints of different colours or textures for the same or different rooms. When the paint is stored in a hermetic sealed environment, the problems of the paint going stale, losing its viscosity and become rigid, having its colour faint, etc. are eliminated as the paint is not longer exposed to the elements. The storage could be short term, during a single project, where the user may for example take some rest or switch to a different paint. It could also be for long term, where the user may store the paint in the system for days during the same job or between different jobs.

In another embodiment of the portable paint system, the axial grooves on the surface of the tray section are configured to have a diamond shaped pattern for allowing even distribution of paint on the roller head when rolled on the diamond shaped pattern and to improve drainage of excess paint from the roller head to the paint reservoir.

In another embodiment of the portable paint system, the hermetic seal between the container and the lid, when the lid is in the closed configuration, is achieved by having a sealing mechanism coupled to the lid, the container or both.

In another embodiment of the portable paint system, the groove is configured to snuggly receive a roller head of a paint roller, wherein when the roller head is received in the groove, pressure is applied by curvature of the groove to the roller head, thereby applying a rinsing effect to drain residual paint from the roller head.

In a further related embodiment, when the roller head is placed in the groove, the roller head is removably secured to the groove.

In another related embodiment of the portable paint system, the lid has at least one of one or more compartments on the upper surface of the lid when coupled to the container for placing one or more of a cup, personal items of a user and paint equipment such as paint brushes and one or more compartments on the inner surface of the lid when coupled to the container for storing and holding paint applicators.

Another aspect of the invention relates to a method of using a portable paint system as described above. The method includes the steps of: pouring paint into the reservoir section of the container; coupling the lid to the container to cover the paint; configuring a first part of the lid to be movable between an open configuration and a closed configuration in relation to a second part of the lid, such that: when the first part of the lid is in the closed configuration, a hermetic seal is created between the lid and the container with the paint stored therein; and when the first part of the lid is in the open configuration, the paint in the container is accessible by a user of the paint system. The method also includes placing a roller head section of a paint roller on the tray section of the container and configuring the lid to be in the closed configuration, wherein a neck section of the paint roller is snuggly fitted into the aperture formed by the indentation in the front wall of the container and the indentation in the lid, wherein the neck section is coupled to a handle section of the paint roller and part of the neck section and the entirety of the handle section extending outside the hermetically sealed container. The method further includes the step of using the handle of the paint roller to maneuver the paint system, while in use to move the paint system from one location to another, without lifting the container and without causing any spillage of paint.

In another aspect of the invention, a method of using a portable paint system as described above, The method comprises the steps of: pouring paint into the reservoir section of the container; coupling the lid to the container to cover the paint; configuring a first part of the lid to be movable between an open configuration and a closed configuration in relation to a second part of the lid, such that: when the first part of the lid is in the closed configuration, a hermetic seal is created between the lid and the container with the paint stored therein; and when the first part of the lid is in the open configuration, the paint in the container is accessible by a user of the paint system. The method also includes the step of placing a roller head section of a paint roller on the tray section of the container in the groove and configuring the lid to be in the open configuration, wherein roller head of the paint roller is snuggly fitted into the groove and wherein a neck section of the paint roller is snuggly fitted into the indentation in the lid, and further wherein the neck section is coupled to a handle section of the paint roller and part of the neck section and the entirety of the handle section extending outside the container. The method further includes the step of using the handle of the paint roller to maneuver the container, while in use to move the paint system from one location to another, without lifting the container and without causing any spillage of paint.

In a replated embodiment, the method further comprising placing an insert inside the container atop the tray section and the reservoir section of the container, where the insert is shaped and dimensioned to fully overlay the tray section and the paint reservoir section of the container; and maintaining a hermetic seal of the container when the lid is configured to be in the closed configuration.

Other aspects and embodiments of the invention will be apparent as will be shown in the detailed description of the invention.

### BRIEF DESCRIPTION OF THE DRAWINGS

The accompanying drawings illustrate non-limiting example embodiments of the invention.

FIG. 1 shows a perspective view of the paint system according to an embodiment of the current invention.

FIG. 1A shows another perspective view of the paint system of FIG. 1.

FIG. 2 shows the paint system of FIG. 1 in an exploded view, where the container is shown to be separated from the lid.

FIG. 3 shows a top view of container of FIG. 1.

FIG. 4 shows the top view of the container of the paint system according to a different embodiment.

FIG. 5 shows a cross sectional view of the container of FIG. 1 along line 5′-5′.

FIG. 6 shows a perspective view of the lid of FIG. 1, where the lid is in the open configuration.

FIG. 7 shows a perspective view of a liner that is fitted into the container of FIG. 1, according to an embodiment of the invention.

FIG. 8 shows a side view of the liner of FIG. 7.

FIG. 9 shows a bottom view of the liner of FIG. 7.

FIG. 10 shows the top view of the liner of FIG. 7.

FIG. 11 shows a perspective view of the paint system of FIG. 1, with the lid shown in the closed configuration.

FIG. 12 shows the paint system of FIG. 11, with the lid in the open configuration and a paint roller having its head resting in the groove of the tray while the handle of the roller extending through the indentation in the sidewall of the container to the outside of the container.

FIG. 12B shows the paint system of FIG. 11 and a paint roller having its head rested in the groove of the tray, while the tray is in the closed configuration and where the handle of the roller is shown to extend outside the paint container, which is hermetically sealed by the lid and the neck of the roller.

FIG. 13 shows the paint system of FIG. 1, with the lid in the open configuration and a paint roller having its head rest in the groove of the tray and the handle of the paint roller extending away from the tray, towards the lid and where a section of the handle of the paint roller rests on the indentation of the side of the lid.

FIG. 14 shows a top view of the embodiment in FIG. 12B.

FIG. 15 shows a cross sectional view of FIG. 14 along line 15′-15′.

FIG. 15A shows a cross sectional view of FIG. 14 along line 15′-15′ according to another configuration, where the roller head rests on the surface of the trade and not in the groove of the tray.

FIG. 16 shows a perspective view of the paint system according to another embodiment of the current invention.

FIG. 17A shows a cross sectional view along a longitudinal axis of the container, according to another embodiment of the invention.

FIG. 17B shows the container of FIG. 17A with the base of the container separated from the container.

FIG. 17C shows a cross sectional view along a longitudinal axis of the container, according to another embodiment of the invention.

FIG. 17D shows the container of FIG. 17C with the base of the container separated from the container.

FIG. 18 shows a bottom perspective view of the container according to another embodiment, where the bottom wall is shown to have an opening plugged by a removable plug.

### DETAILED DESCRIPTION

Throughout the following description, specific details are set forth in order to provide a more thorough understanding to persons skilled in the art. However, well known elements may not have been shown or described in detail to avoid unnecessarily obscuring the disclosure. The following description of examples of the technology is not intended to be exhaustive or to limit the system to the precise forms of any example embodiment. Accordingly, the description and drawings are to be regarded in an illustrative, rather than a restrictive, sense. Like reference numerals are used to refer to like specific parts, or elements, of the various Figures.

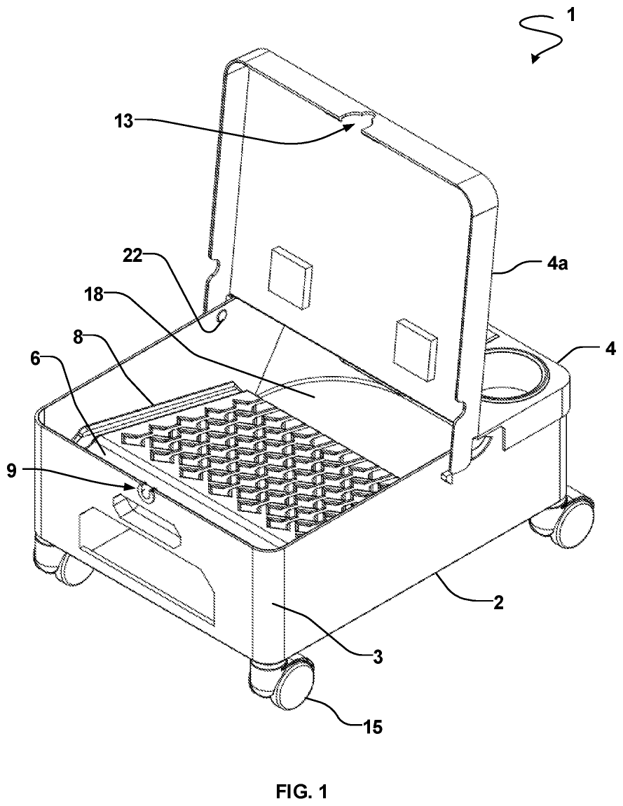

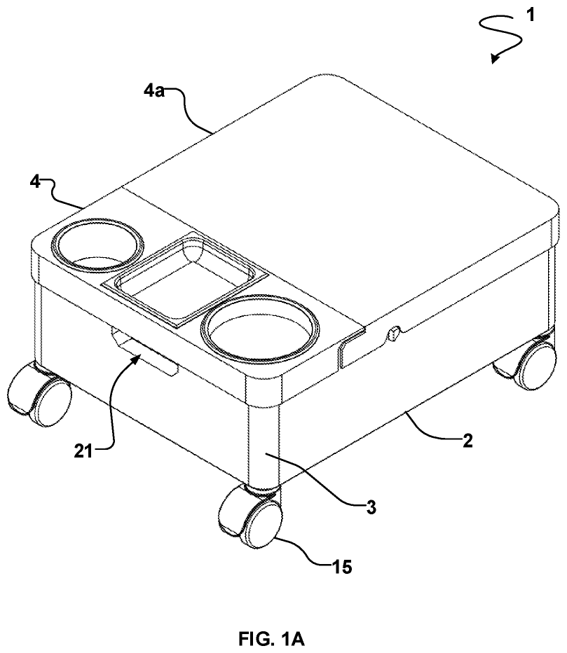

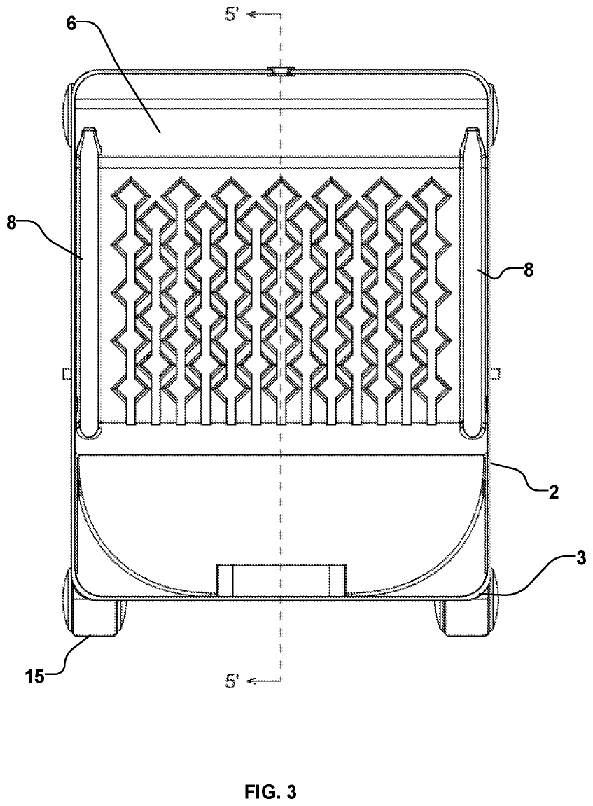

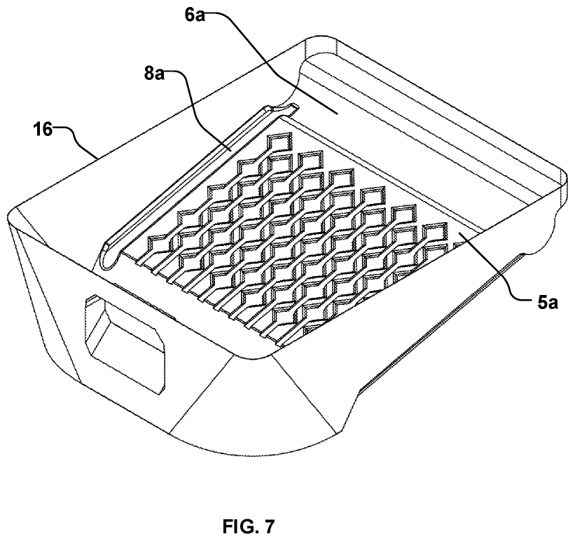

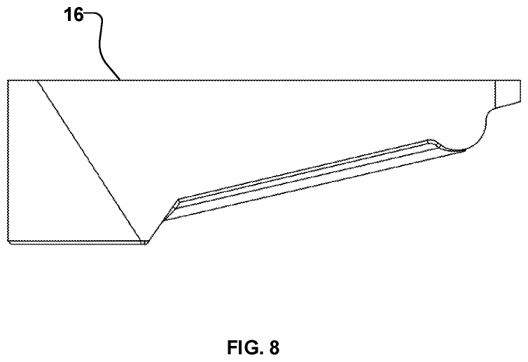

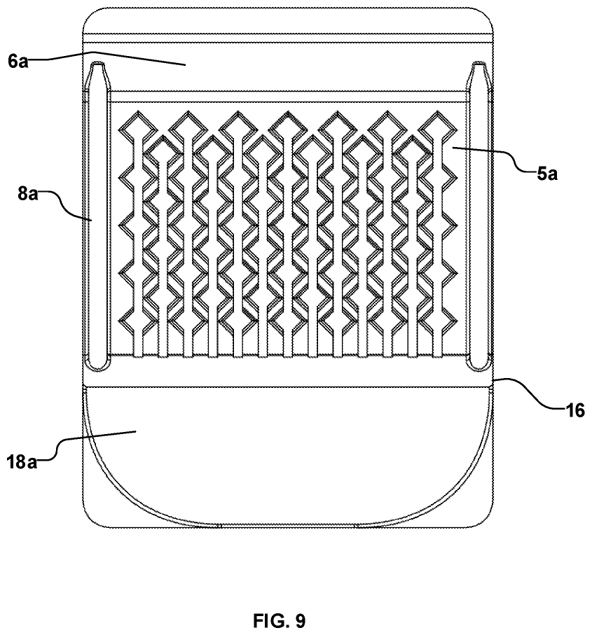

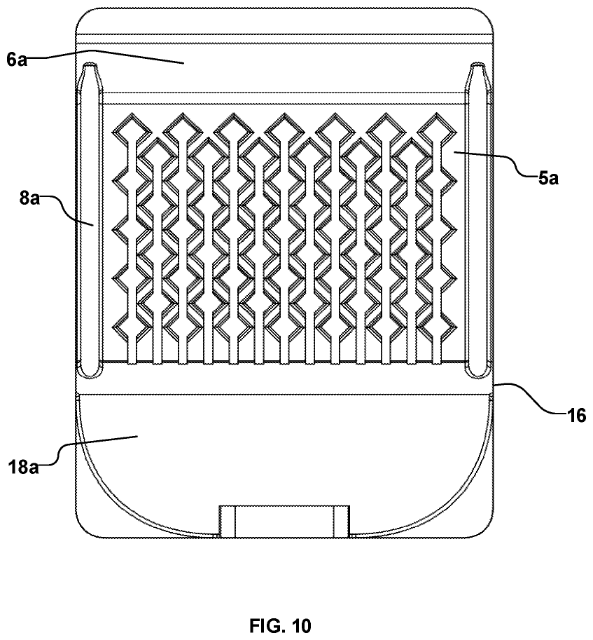

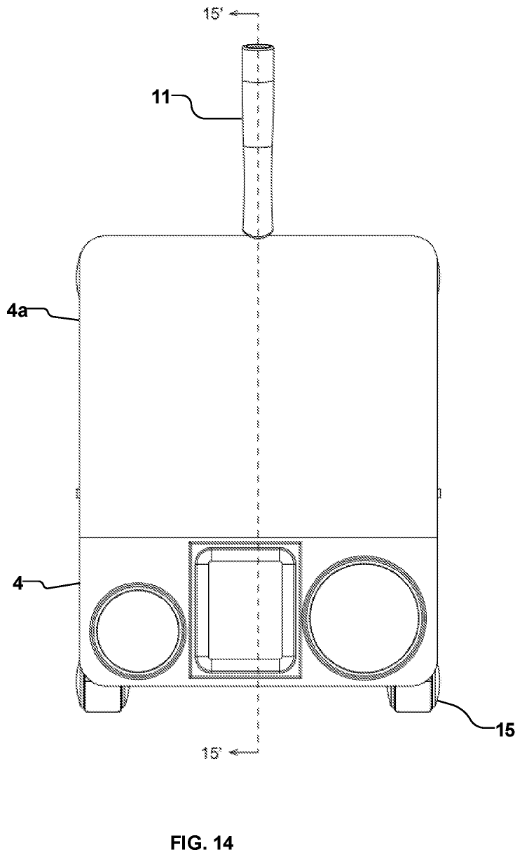

FIG. 1 to FIG. 15 show various elements of a paint system according to multiple embodiments of the current invention. FIG. 1, shows a perspective view of the paint system 1 according to an embodiment of the invention. Paint system 1 is shown to include a container 2. Container 2 is shown in this embodiment to have a rectangular cross section. It is to be understood that in other embodiments (not shown) container 2 may have other cross-sectional shapes known in the art that fit the structure and function described below. Container 2 is shown to have curved corners 3. Paint system 1 also includes a lid 4, which is designed to have an open or a closed configuration. Lid 4 is configured to cover the open end of container 2 and lid 4 is removably couplable to container 2, such that when lid 4 is fitted to the top edge of the open end of container 2 and when lid 4 is in the closed configuration, a seal is created along the edges of lid 4 and container 2.

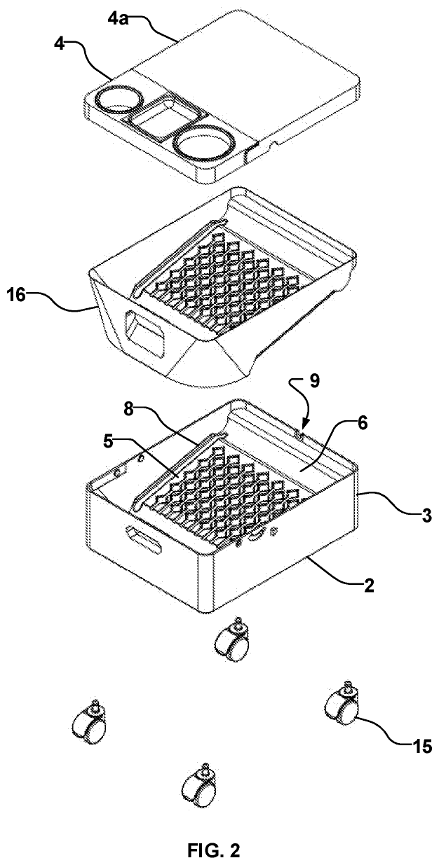

In FIG. 1, lid 4 is shown to have an open configuration. FIG. 2 shows an exploded view of the paint system in FIG. 1, where lid 4 is shown to be in the closed configuration. When lid 4 is coupled to container 2, while in the closed configuration, the entire open end of container 2 is covered and is hermetically sealed by lid 4. The seal is established in the current embodiment by providing a layer (not shown) on the lip of either lid 4, container 2 or both, such that when lid 4 is coupled to the open end of container 2, the layer is slightly pressed. The layer may be made from rubber, silicone, plastic, or any other material known in the art for scaling airtight containers.

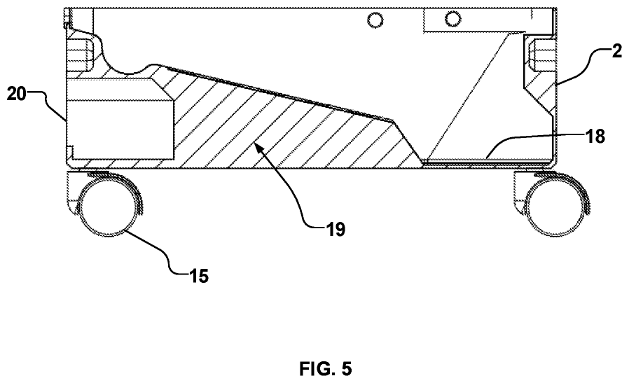

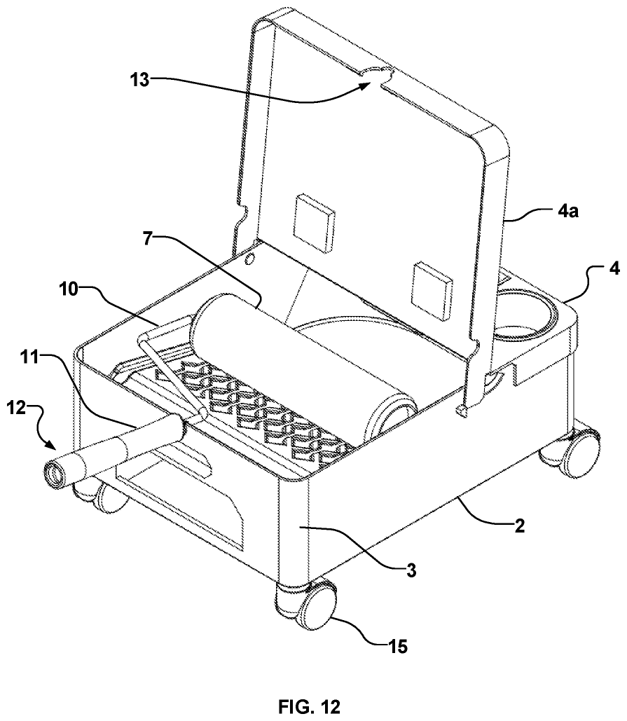

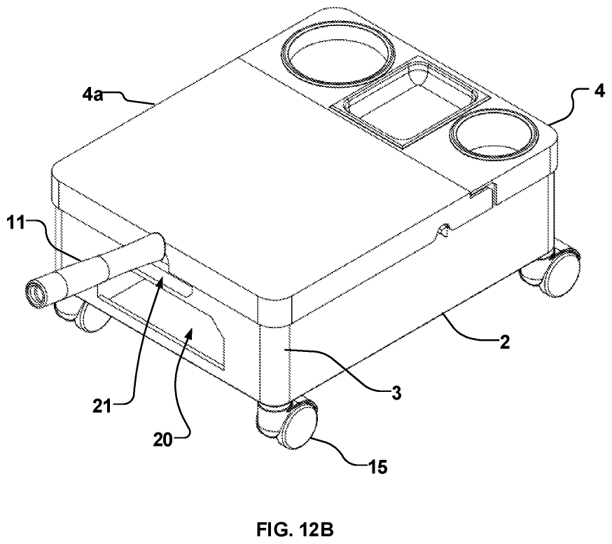

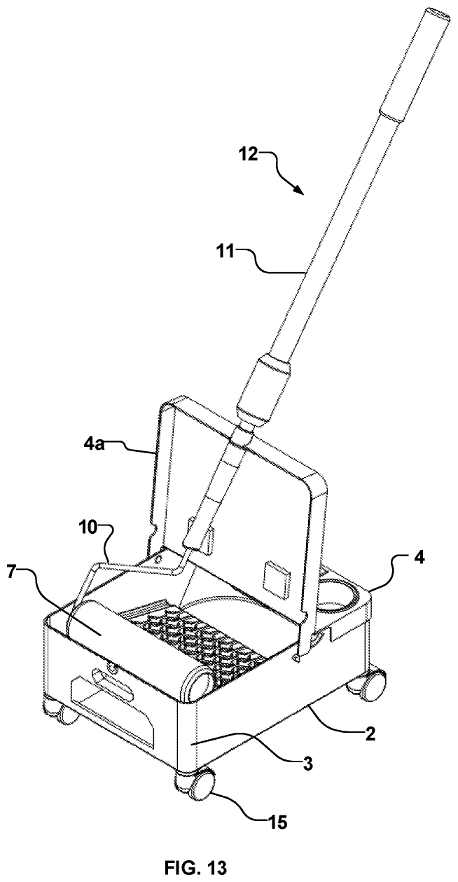

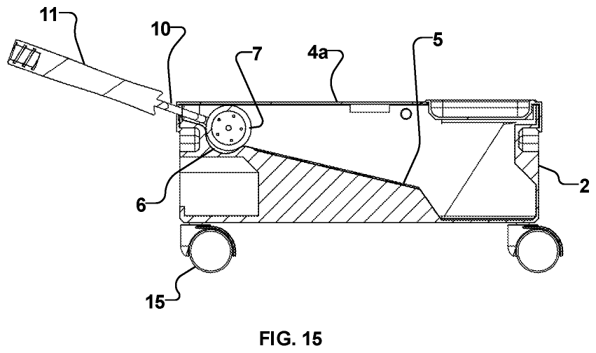

Referring to FIG. 2, container 2 is shown to have paint tray 5 positioned inside container 2. In the current embodiment, paint tray 5 is shown to be integral to container 2. In other embodiments (not shown), paint tray 5 may be removable from container 2. Paint tray 5 is configured to have a sloped surface from substantially a top edge of container 2 to a point on the base of container 2, which is near the center of container 2. This is best represented in FIG. 5. Tray 5 also has a groove 6 along its width configured for receiving the roller head of a paint roller, when rested on the tray while not in use. Examples of this may be shown in FIG. 12B, FIG. 13 and FIG. 15. In some embodiments such as FIG. 15, groove 6 is configured to be deep enough to receive roller head 7 and allow lid 4 to be coupled to the top end of container 2 to create the hermetic seal, as shown in FIG. 12B and FIG. 15. In another embodiment, such as the one in FIG. 15A, roller head 7 may be rested on tray 5 but not in groove 6. This is done to allow for the hermetic seal to be established between the container 2 and lid 4 with the roller head inside, when the roller head size does not allow for it to be fitted into groove 6 while still allowing lid 4 to be in the closed configuration.

Paint tray 5 in the embodiment provided is shown to have a channel 8 on each of the tray's sloped edges along its length. Channels 8 are configured to allow for drainage of paint from roller head 7 to the base of container 2, when a wet roller head 7 is rested on groove 6. In some embodiments, paint tray 5 may have more than 2 channels (not shown) along its sloped length. In other embodiments (not shown) paint tray 5 may have only one channel along its sloped length. The width of channel 8 may vary across different embodiments. Some factors that may contribute to such variation are the overall size of container 2 and tray 5, the size of the rollers head, which would dictate the amount of paint to be drained from the roller head through channels 8. By way of non-limiting example, the width of channel 8 may range between 18 to 25 mm.

In some embodiments, groove 6 is configured to snuggly receive roller head 7, such that when roller head 7 is received in groove 6, pressure is applied by the curvature of groove 6 to the roller head 7, thereby applying a rinsing effect to the roller head 7 to drain the paint from it. The snuggly fit also allows for groove 6 to securely receive roller head 7, so that when roller head 7 is pressed into groove 6, some pressure is required to separate the roller head 7 from groove 6. In other embodiments, groove 6 may be configured to simply receive roller head 7 and additional mechanism may be used to secure roller head 7 to tray 5 while placed on groove 6. Various mechanisms known in the art may be utilized for this purpose. As a non-limiting example, roller head 7 may have a male part on either edge of its edges (not shown) that is received and clipped on by a corresponding female cavity (not shown) on tray 5. Another non-limiting example may be a mechanical harness (not shown) that may be applied to roller head 7, when rested on groove 6, where the harness securely engages with a part of tray 5 or side walls of container 2 to securely hold roller head 7 in place.

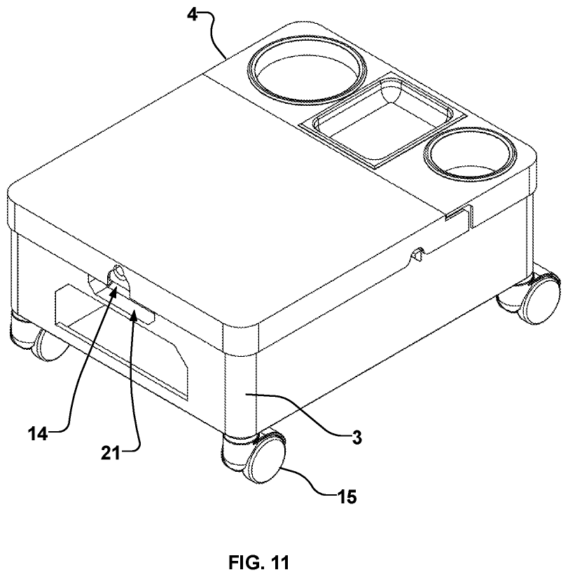

Referring back to container 2 in FIG. 2 and FIG. 12, the edge of the open end of container 2 adjacent to the top end of tray 5 is shown to have an indentation 9 to accommodate a neck part 10 of handle 11 of paint roller 12. A corresponding indentation 13 is also found on the edge of lid 4 matching in size, width and location to indentation 9 of container 2. When lid 4 is coupled to the open end of container 2, Indentations 9 and 13 form an aperture 14 sufficient to accommodate the neck 10 of roller 12. This is best shown in FIG. 11 and FIG. 12. When roller head 7 is rested on groove 6 and neck 10 is received into the aperture 14 formed by indentations 9 and 13, the aperture 14 is configured to be completely plugged by neck 10 to maintain a hermetic seal between lid 4 and container 2. In some embodiments, the seal is established by having a thin layer (not shown) lacing the indentations 9 and 13. Such thin layer may be formed of rubber, silicone, plastic or any other material known in the art for sealing airtight containers. It is to be understood that other means known in the art may be used to establish the same effect.

When roller 12 is removed from tray 5, the hermetic seal between lid 4 and container 2 may still be maintained by placing a plug (not shown) into aperture 14. Such plug may be made of any material known in the art for such purpose. As non-limiting examples, such material may be plastic, silicone, rubber and certain metals suitable for establishing airtight containment when used to plug aperture 14. By way of non-limiting example, in some embodiments, aperture 14 may be sealed by a simple cork. In other embodiments, aperture 14 may be sealed by other mechanisms such as cap or a cover that may be threaded into the aperture lining or affixed to the outside surface of aperture 14.

FIG. 12 shows roller 12 in place in one configuration, when rested on sloped tray 5. The sloped plane of tray 5 serves to allow drainage of paint through channels 8 due to gravity. The sloped plane of tray 5 along with the aperture 14 created by indentations 9 and 13 allow for handle 11 of paint roller 12 to extend away from the paint system in an inclined plane. This allows a user to hold the handle by hand 11, while in a standing position.

Container 2 is shown in FIGS. 1, 2, and 11 to 14 to have wheels 15 affixed to the bottom side of the container. The wheels 15 shown in the figures are 360 degree access wheels. However, it is to be understood that other types of wheels, casters and glides known in the field for moving furniture and devices may be used. Wheels 15 are removably coupled to container 2 to allow easy cleaning and replacement of same. In some embodiments, wheels 15 are permanently affixed to the base of container 2.

The combination of the sloped surface of tray 5, aperture 14 and wheels 15 allow a user to maneuver the paint system 1 when lid 4 is coupled in closed configuration to container 2 and paint roller 12 is positioned so that neck 10 seals aperture 14 and handle 11 extends outside paint system 1. Specifically, the user is able to hold the handle 11 and either drag or push the paint system 1 to a desired location while maintaining the paint in container 2 fresh and without the need to carry any of the paint system parts to relocate it. This feature allows the user to paint different parts of a location, such as different rooms of a house, efficiently. Also, due to the hermetic seal provided between lid 4 and container 2, the use of paint system 1 also allows for cost savings since the paint and roller are not frequency replaced.

In some embodiments, handle 11 of paint roller 12 may also be used to maneuver paint system 1 when the lid 4 is in an open configuration or when lid 4 is not coupled to container 2. In such embodiments, the positioning of the roller head 7 on groove 6, the fitting of neck 10 of roller 12 into indentation 9 of container 2 and the coupling of wheels 15 to the base of container 2 provides the user a sufficiently stable structure to maneuver container 2 using handle 11 of the roller 12. Such use may allow for faster operation during the process of painting.

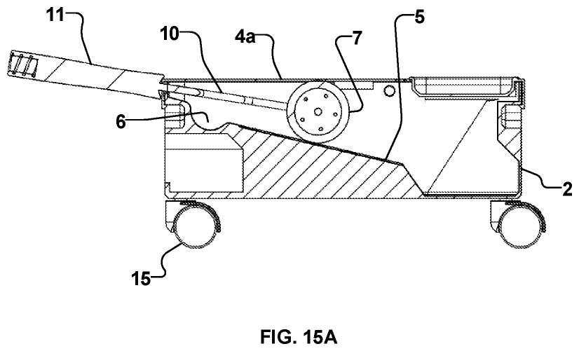

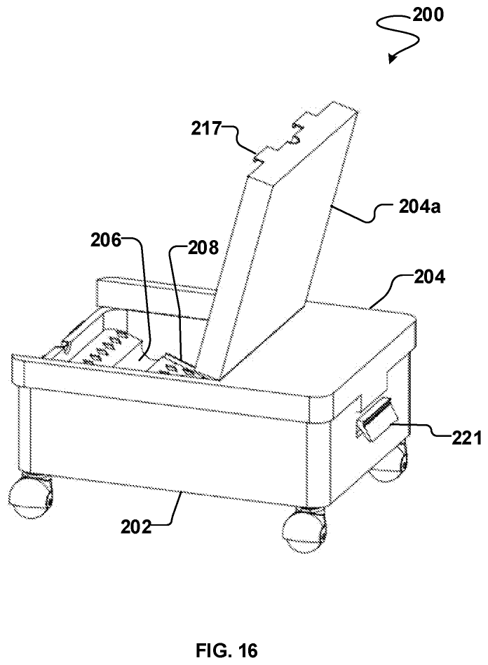

In some embodiments, container 2 has handles 21 that allow the user to carry the entire system if needed, for example to move the paint system 1 from one floor to another over a flight of stairs. It is to be understood that any type and configuration of handles known in the art may be used. FIGS. 1 and 1A show a non-limiting example of handles 21 formed as openings in the two opposing short edges of container 2. FIG. 16 shows another non-limiting example of the handle 221, which protrude from the front and back of the system and allows the user to grip the edges of the handles when carrying the paint system 200. It is to be understood that other embodiments may have different number, shape and position of the handles, where the user may use such handles to carry the paint system without causing spillage to the paint contained therein.

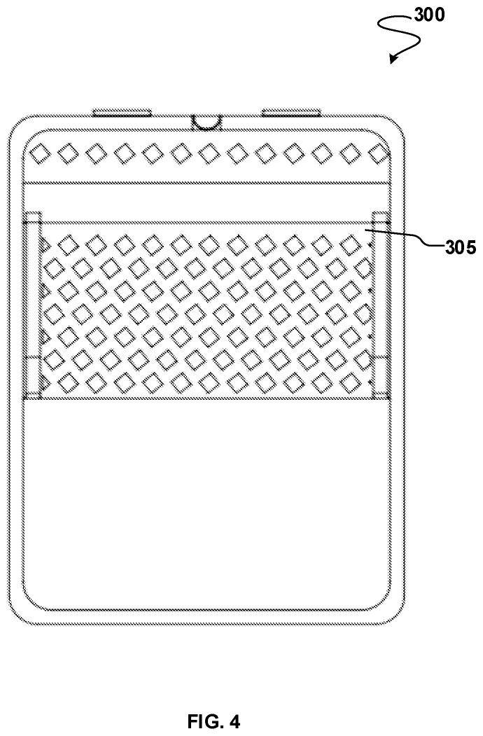

In FIGS. 1 to 3, tray 5 shows a diamond shaped pattern grooved surface. The layered design of the diamond shape pattern allows for even distribution of paint on the roller head 7 and the grooves running through the diamond pattern allows for more efficient and improved drainage. The size of the diamond shaped pattern and the number of rows may be changed in different embodiments of the invention. Also, it is to be understood that other patterns known in the art may be used. FIG. 4 shows another embodiment of paint system 300 representing a non-limiting exemplary different pattern for the grooved surface of tray 305.

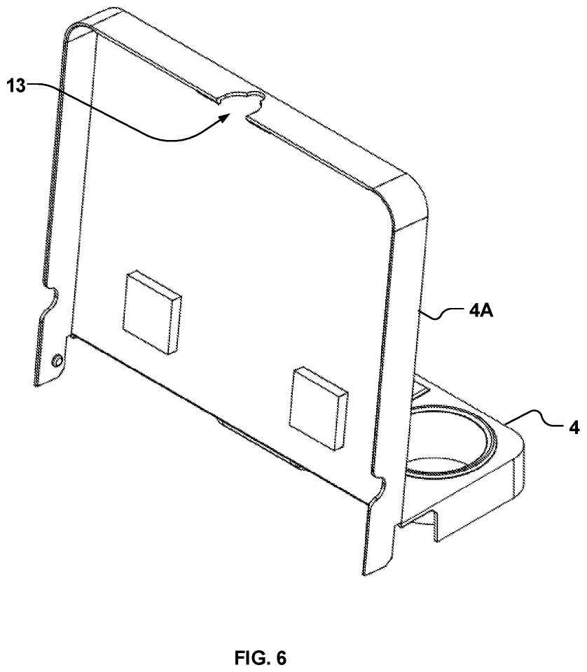

Lid 4 is described to have an open and a closed configuration. In the closed configuration, as shown in FIG. 11, lid 4 creates a hermetic seal with container 2. In an open configuration, lid 4 is partially coupled to container 2. This is shown in FIGS. 1, 12 and 13. In all figures, lid 4 is comprised of two sections coupled to each other or to the container 2 by a hinge. In some embodiments, the open configuration is established by having a first section 4a of lid 4 pivot across the hinge (not shown) to move away from the corresponding edge of the open end of container 2. In some embodiments, the movable section of the lid, i.e. 4a may be coupled to the sides of the container 2 by a hinge 22, allowing the lid section 4a to pivot in relation to the other section of the lid, i.e. 4, which is coupled to the container 2. First section 4a, when in open configuration moves away from the edge of open container 2 on which indentation 9 is present. When lid 4 is in the open configuration, sections 4a and 4 do not share the same plane. As such, the open configuration allows for the roller head 7 and roller 12 to be removable from paint system 1 for use by the user. In FIG. 1, FIGS. 6, 12 and 13, first section 4a is the same width as container 2 and as such, when in open configuration, only part of the long side edges of lid 4 are couple to the lips of open end of container 2. Such design and configuration provides sufficient sturdiness and stability of painting system 1 when handling and cleaning.

In another embodiment, shown in FIG. 16, system 200 is presented, in which section 204a may be narrower in width than the width of container 202. In such embodiment, lid 204 may be coupled to the entirety of all edges of the open end of container 202 apart from one edge, from which first section 4a may extend away to form the open configuration. In such embodiment, a roller may still rest on groove 206 and be drained of paint through channels 208.

Another use of indentation 13 on section 4a of lid 4 may be shown in FIG. 13, where the indentation is used to receive the handle 11 of paint roller 12 during operation, when the user wishes to have a quick rest for example. In the embodiments shown in the figures, lid 4 is shown to optionally have compartments on the inner side of section 4a for storing and holding different paint applicators. Different mechanism known in the art may be used for holding the paint applicators. For example, such mechanisms may include magnets, clips, Velcro tape, etc. The figures also shows that the upper side of lid 4 may be optionally configured to have cup holders or compartments for holding painting equipment for example.

When first section 4a is in the closed position, such position may be maintained by various mechanisms known in the art for securing first section 4a to the corresponding edge of open end of container 2. Suh mechanisms may comprise a hook (shown as 217 in FIG. 16) by way of non-limiting example. Other mechanisms known in the art, such as magnets by way of non-limiting example, may be used to establish the same purpose.

Paint system 1 may also comprise a liner 16, shown in FIGS. 2 and 7 to 10. Liner 16 corresponds in shape and dimensions to the inner surface of container 2, such that liner 16 is perfectly fitted into the inner side of container 2 and overlays tray 5 and the exposed part 18 of container 2. As such, liner 16 includes channels 8a, groove 6a, inclined tray surface 5a and exposed base section 18a. Liner 16 allows for maintaining the container clean in events where multiple colours are required for a paint job. In such circumstances, each liner 16 may be matched with its own lid 4 to maintain a hermetic seal when not in use to preserve the freshness of the paint and to prevent drying of the paint and paint roller head 7. Liner 16 is dimensioned such that when fitted on the inner side of container 2, lid 4 is able to maintain a hermetic seal when couple to container 2. In some embodiments, the front edge of liner 16 is positioned just below indentation 9 so as not to obstruct the paint roller handle at neck 10 of roller 12 when the system is in the closed position to maintain the hermetic seal between lid 4 and container 2. In other embodiments (not shown), the front edge of liner 16 may be configured to have a corresponding indentation corresponding in shape and size to indentation 9 of container 2.

Section 18 of container 2 may be sized to hold various volumes of paint. For example, section 18 may hold a gallon of paint. Ideally, the paint level in section 18 is desired to be below groove 6 to allow for drainage of roller head 7, when placed on groove 6. As shown in FIG. 5, section 18 serves as a reservoir for paint. In this embodiment, the section of container 2 below tray 5 (marked with diagonal lines and referenced as 19) is separated by tray 5 from the other side of container 2. In such embodiment, section 19 may be used for storage of paint canisters or anything else that may be fitted there such as personal items of the user or paint equipment such as brushes, rollers, applicators, or the like. Alternatively, only a portion of section 19, labelled as section 20, may be formed as a pocket for the user to store some items such as personal items and paint brushes and the like during use of paint system 1.

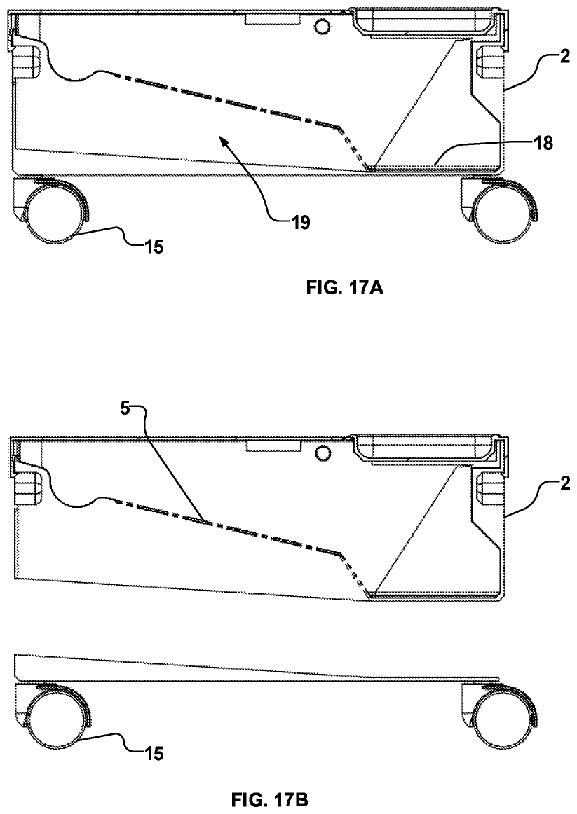

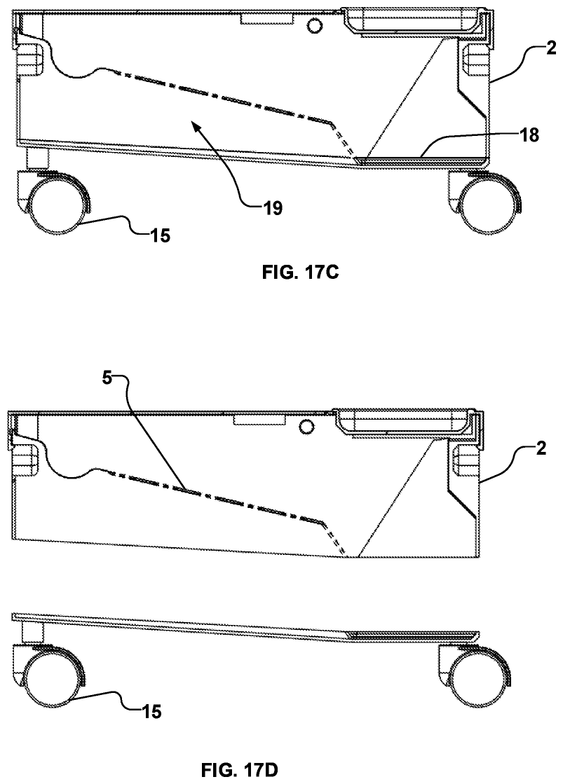

In FIG. 5, the surface of tray 5 is solid and unperforated, which allows for separating section 19 from the top side of tray 5. In some embodiments, tray 5 may be perforated, such as shown in FIG. 17A to 17D. For example, the diamond pattern on tray 5 may be hollow. This allows for paint on the surface of tray 5 to drain to section 19. In such embodiment, section 19 may act as extra paint storage and reservoir. In such embodiment, container 2 may be configured to hold a larger volume of paint. It is still preferred to have any volume of paint stored in section 19 be below groove 6 to allow drainage of roller head 7. Also, to allow access by the roller head 7 to the paint in section 19, the bottom surface of container 2 defining the base of section 19 is preferred to be inclined to allow paint in section 19 to move to section 18 through the perforated tray 5. In some embodiments, mechanical mechanisms may be used to push the paint reservoir from section 19 to section 18 through tray 5. In this embodiment, the base of container 2 may be detachable to allow for easy cleaning of section 19.

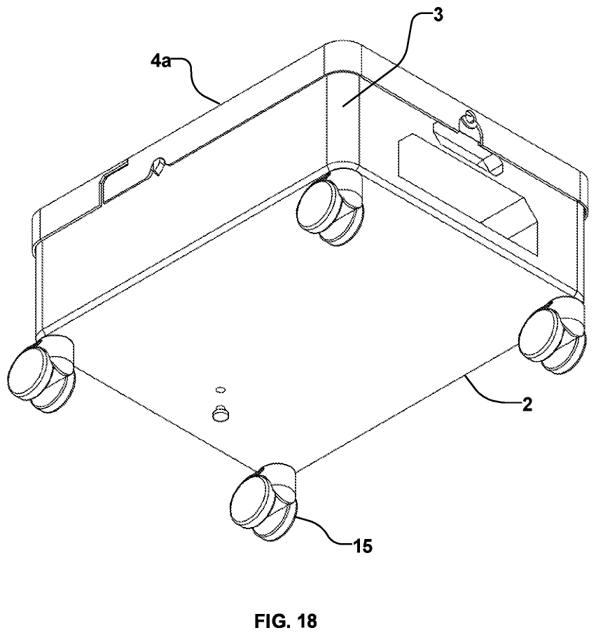

Container 2 is shown to have curved corners 3 in FIGS. 1 to 3 and 11 to 13. Such feature is beneficial in draining paint from container 2 during the cleaning process of the container. The curved edges provide a smooth path for the paint to be drained out of container 2 and into the original paint container if required or otherwise. The embodiment described is shown to have easy pour corners that are tapered to allow for more precision when recovering paint to the original paint container. In other embodiments (shown in FIG. 18), instead of flipping the container 2 to drain and remove the paint in section 18, drainage of paint from container 2 may be achieved in other ways. For example, in some embodiments, as shown in FIG. 18, an opening may be added at the base (bottom) or sides of container 2 to allow drainage of any paint out of the paint reservoir in section 18, without the need to flip container 2. Such opening may be positions at various parts of the base or side of container 2. In some embodiments, more than one opening is present to allow for pressure release inside the container if drainage is desired when the hermetic seal is engaged. Such opening(s) may be plugged with a drain plug, that may be made from rubber, plastic, silicone or any other material used for maintaining a seal for storing liquids. In such embodiment, as the paint is drained from container 2 in the upright or tilted position, the base of container 2 may be tapered so that the drain opening is the lowest point of the base of container 2 and the remaining of the base surface area is tapered towards the drain opening. Such features allow for paint to drain from container 2, when the drain plug is removed, under the influence of gravity.

Various embodiments of the paint system have been described in this disclosure. It is to be understood that the container, lid and insert forming the paint system may be made from any material know in the art for manufacturing such components for the intended use.

According to one method of use, in operation, the user will pour a desired colour of paint into section 18 of container 2. Lid 4 is then coupled to container 2 and is maintained in the closed configuration to preserve the freshness of the paint in the container. Aperture 14 is also sealed with a flange when roller 12 is not present. The flange is not needed if roller 12 is present as the neck 10 of roller 12 will be sufficient to seal aperture 14 when roller 12 is used with the system, as shown in FIG. 12B. When the user intends to use the paint, the seal of aperture 14 is removed and section 4a is moved to the open configuration. The user then dips the roller head into the paint in section 18 and then rolls it on the surface of tray 5 to obtain a desired even distribution of paint on the roller head 7. When the paint roller 12 is in use for painting, section 4a may be moved into the closed configuration to maintain a hermetic seal of the container 2. Section 4a is then moved back again into an open configuration when the user wishes to replenish the paint on the roller head 7 and then move section 4a back to a closed configuration afterward. These steps would be repeated by the user throughout the painting job. When the user wishes to relocate the paint system 1, the roller head 7 is placed on and secured to groove 6, section 4a is moved to the closed configuration and the user then uses the handle 11 of roller 12 to maneuver paint system 1 to the desired location without having to lift any parts of the system. While in place under hermetic seal, roller head 7 is drained of the paint through channels 8 into the paint reservoir in section 18.

According to another method of use, in operation, the user will set up the paint system and load it with paint similar to the above described method. When the user intends to use the paint, the seal of aperture 14 is removed and section 4a is moved to the open configuration. The user then dips the roller head into the paint in section 18 and then rolls it on the surface of tray 5 to obtain a desired even distribution of paint on the roller head 7. When the user uses the roller for painting, in this method of use, section 4a of the lid 4 is maintained open. This will allow the user easy access to the paint reservoir in section 18 and to tray 5 without any delay that may be experienced in moving section 4 a between a closed and an open configuration every time the user needs to replenish the paint on the roller in use. In such method, the paint will be maintained fresh even with the lid section 4a being open during operation. This is because paint maintains its freshness while exposed to the elements, when the surface of the paint is regularly disturbed. In operation, the use of the roller for painting and the replenishment of the paint on the roller head 7 is sufficiently quick to maintain the paint in section 18 fresh despite the lid section 4a being open during operation. Further, because the user is able to maneuver the entire paint system 1 by placing the roller on groove 6 of tray 5, while section 4a is in the open configuration, the user is able to cover painting of surfaces a lot faster compared to having to relocate the paint tray and painting equipment as the user progresses through the painting job to other parts of the house, building, etc. Because of this fast coverage of an area, when the user refreshes the paint on the roller head during operation, the user is able under such method of use to perform the painting job, while section 4a is maintained open, without having to worry about the freshness of the paint in the reservoir. Under such method, a significant increase in efficiency in a painting job is observed.

Thus, in accordance with the systems and methods described in the present invention, a new paint system is provided, which allows for efficient painting and long-term storage of paint once removed from the original paint container. Specifically, this new paint system allows for more speed through maneuverability and carrying tools, which increases overall efficiency. Long term storage of paint means less mess and damage to surfaces from spillage, which reduces the requirement of cleaning and disposing of dried paint and replacing rollers. This paint system also reduces the use of plastics to store paint in trays and reduces water consumption for cleaning up after jobs. The systems and methods also provide cost savings by reducing the requirement to clean and dispose of dried paint and replace paint roller head due to same. The invention allows users to move the system without much bending at the waist, lifting and/or carrying, which in commercial applications can reduce worker compensation claims from back and neck injuries.

### Interpretation of Terms

Unless the context clearly requires otherwise, throughout the description and the claims:
“comprise,” “comprising,” and the like are to be construed in an inclusive sense, as opposed to an exclusive or exhaustive sense; that is to say, in the sense of “including, but not limited to”.
“connected,” “coupled,” or any variant thereof, means any connection or coupling, either direct or indirect, between two or more elements; the coupling or connection between the elements can be physical, logical, or a combination thereof.
“herein,” “above,” “below,” and words of similar import, when used to describe this specification shall refer to this specification as a whole and not to any particular portions of this specification.
“or,” in reference to a list of two or more items, covers all of the following interpretations of the word: any of the items in the list, all of the items in the list, and any combination of the items in the list.
the singular forms “a”, “an” and “the” also include the meaning of any appropriate plural forms.
“user”, “subject”, “individual”, “participant” are understood to be used interchangeably in the disclosure and to refer to a bipedal animal, like a human.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, “upper”, “lower” and the like, used in this description and any accompanying claims (where present) depend on the specific orientation of the apparatus described and illustrated. The subject matter described herein may assume various alternative orientations. Accordingly, these directional terms are not strictly defined and should not be interpreted narrowly.

Where a component (e.g. a circuit, module, assembly, device, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of system and method have been described herein for purposes of illustration. These are only examples. The technology provided herein can be applied to device and method other than the examples described above. Many alterations, modifications, additions, omissions and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

It is therefore intended that the following appended claims and claims hereafter introduced are interpreted to include all such modifications, permutations, additions, omissions and sub-combinations as may reasonably be inferred. The scope of the claims should not be limited by the preferred embodiments set forth in the examples, but should be given the broadest interpretation consistent with the description as a whole.

What is claimed is:

1. A portable paint system comprising:
a container having:
a front wall, a back wall, at least two opposing side walls and a bottom wall, the at least two opposing sides walls coupled to the back wall to form vertical curved pour corners of the container for providing a smooth path for draining paint from the container, the front wall having an indentation at its top edge for receiving a neck section of a paint roller;
a paint reservoir section defined by portions of the at least two opposing side walls, the back wall and the bottom wall;
a tray section having a surface extending between the at least two opposing side walls and extending downwardly in a sloped plane from the front wall to the paint reservoir section, the tray section having a groove extending laterally between the at least two opposing side walls for receiving a roller head of a paint roller, the tray section further having at least one paint channel extending axially along the surface of the tray from the groove to the paint reservoir section, the tray section surface having axial grooves along the surface of the tray section;
a lid dimensioned to be removably coupled to the container and to cover the container in one of a closed configuration and an open configuration, the lid forms a hermetic seal with the container when fully covering the container in the closed configuration, the lid having an indentation corresponding in shape, size and position to the indentation at the top edge of the front wall of the container, such that when the lid is coupled to the container in the closed configuration, an aperture is formed by the combination of the indentation in the front wall of the container and the indentation in the lid, the aperture is dimensioned to snuggly fit a neck section of a paint roller; and
removable wheels coupled to the bottom wall and exterior to the container, the removable wheels configured to make the container portable.

2. The portable paint system of claim 1, the paint system further comprising an insert for placement inside the container atop the tray section, the insert is shaped and dimensioned to fully overlay the tray section and the paint reservoir section of the container and to allow the lid to maintain a hermetic seal of the container when in the closed configuration.

3. The portable paint system of claim 1, wherein the lid comprises a first part and a second part coupled to each other by a hinge and the lid is moved from the closed configuration to the open configuration by allowing the first part to pivot along the hinge in relation to the second part.

4. The portable paint system of claim 1, wherein the lid comprises a first part coupled to a section of the container by hinges and a second part coupled to the at least two opposite side walls of the container and the lid is moved from the closed configuration to the open configuration by allowing the first part to pivot along the hinges in relation to the second part.

5. The portable paint system of claim 1, wherein the container further has an additional section under the surface of the tray section, the additional section configured for storing paint equipment or personal items of a user of the paint system.

6. The portable paint system of claim 1, wherein the tray section of the container has a perforated sloped section.

7. The portable paint system of claim 6, wherein the container further comprises an additional section under the surface of the tray section, the additional section configured for acting as a second paint reservoir.

8. The portable paint system of claim 7, wherein the bottom wall of the container is removable.

9. The portable paint system of claim 1, wherein the bottom wall comprises at least one opening plugged by a removeable plug, the at least one opening for draining paint from the paint reservoir when the plug is removed, with the container maintained substantially in an upright orientation.

10. The portable paint system of claim 1, wherein the hermetic seal is achieved when a paint roller head is placed inside the container, the neck section of the paint roller is placed in the aperture such that a handle section of the paint roller extends externally from the container and wherein the lid is placed in the closed configuration.

11. The portable paint system of claim 1 configured for one of long or short term storage of paint, wherein the hermetic seal is achieved when the lid is placed in the closed configuration and wherein the aperture is plugged with an aperture plug to seal the aperture.

12. The portable paint system of claim 1, wherein the axial grooves on the surface of the tray section are configured to have a diamond shaped pattern for allowing even distribution of paint on the roller head when rolled on the diamond shaped pattern and to improve drainage of excess paint from the roller head to the paint reservoir.

13. The portable paint system of claim 1, wherein the hermetic seal between the container and the lid, when the lid is in the closed configuration, is achieved by having a sealing mechanism coupled to the lid, the container or both.

14. The portable paint system of claim 1, wherein the groove is configured to snuggly receive a roller head of a paint roller, wherein when the roller head is received in the groove, pressure is applied by curvature of the groove to the roller head, thereby applying a rinsing effect to drain residual paint from the roller head.

15. The portable paint system of claim 14, wherein when roller head is placed in the groove, the roller head is removably secured to the groove.

16. The portable paint system of claim 1, wherein the lid has at least one of one or more compartments on the upper surface of the lid when coupled to the container for placing one or more of a cup, personal items of a user and paint equipment such as paint brushes and one or more compartments on the inner surface of the lid when coupled to the container for storing and holding paint applicators.

17. A method of using a portable paint system as described in claim 1, the method comprising:
pouring paint into the reservoir section of the container;
coupling the lid to the container to cover the paint;
configuring a first part of the lid to be movable between an open configuration and a closed configuration in relation to a second part of the lid, such that:
when the first part of the lid is in the closed configuration, a hermetic seal is created between the lid and the container with the paint stored therein; and
when the first part of the lid is in the open configuration, the paint in the container is accessible by a user of the paint system;
placing a roller head section of a paint roller on the tray section of the container and configuring the lid to be in the closed configuration, wherein a neck section of the paint roller is snuggly fitted into the aperture formed by the indentation in the front wall of the container and the indentation in the lid, wherein the neck section is coupled to a handle section of the paint roller and part of the neck section and the entirety of the handle section extending outside the hermetically sealed container; and
using the handle of the paint roller to maneuver the paint system, while in use to move the paint system from one location to another, without lifting the container and without causing any spillage of paint.

18. A method of using a portable paint system as described in claim 1, the method comprising:
pouring paint into the reservoir section of the container;
coupling the lid to the container to cover the paint;
configuring a first part of the lid to be movable between an open configuration and a closed configuration in relation to a second part of the lid, such that:
when the first part of the lid is in the closed configuration, creating a hermetic seal between the lid and the container with the paint stored therein; and
when the first part of the lid is in the open configuration, the paint in the container is accessible by a user of the paint system;
placing a roller head section of a paint roller on the tray section of the container in the groove and configuring the lid to be in the open configuration, wherein head section of the paint roller is snuggly fitted into the groove and wherein a neck section of the paint roller is snuggly fitted into the indentation in the lid, and further wherein the neck section is coupled to a handle section of the paint roller and part of the neck section and the entirety of the handle section extending outside the container; and
using the handle of the paint roller to maneuver the container, while in use to move the paint system from one location to another, without lifting the container and without causing any spillage of paint.

19. The method according to claim 17, the method further comprising placing an insert inside the container atop the tray section and the reservoir section of the container, the insert is shaped and dimensioned to fully overlay the tray section and the paint reservoir section of the container; and
maintaining a hermetic seal of the container when the lid is configured to be in the closed configuration for one of long or short term storage of paint in the container.
